(19) United States
(12) Patent Application Publication
(10) Pub. No.: US 2013/0181810 A1
(43) Pub. Date: Jul. 18, 2013

(54) ERGONOMIC REMOTE CONTROL GLOVE

(71) Applicant: Vadim Plotsker, Amherst, NH (US)

(72) Inventor: Vadim Plotsker, Amherst, NH (US)

(73) Assignee: BAE Systems Information and Electronic Systems Integration Inc., Nashua, NH (US)

(21) Appl. No.: 13/825,390

(22) PCT Filed: Jul. 19, 2012
(86) PCT No.: PCT/US12/47279

§ 371 Date: Mar. 21, 2013

Related U.S. Application Data
(60) Provisional application No. 61/510,102, filed on Jul. 21, 2011.

(51) Int. Cl. G05B 1/01

(52) U.S. Cl. CPC G05B 1/01
USPC 340/5.52; 340/5.51

(57) ABSTRACT

An ergonomic remote control glove for controlling an electronic device in military applications is disclosed. In one embodiment, the ergonomic remote control glove includes at least one motion sensor and a processor communicatively coupled to the at least one motion sensor. Further, the ergonomic remote control glove includes a communication link to connect to the electronic device. The communication link is communicatively coupled to the processor. Furthermore, the ergonomic remote control glove includes a wearable ergonomic glove configured to include the at least one motion sensor, the processor and the communication link. The processor is configured to send one or more control signals to the electronic device via the communication link upon detecting finger motions and/or hand gestures by the motion sensor.

### CROSS-REFERENCE TO RELATED APPLICATION

This Application claims rights under 35 USC §119(e) from U.S. application Ser. No. 61/510,102 filed Jul. 21, 2011, the contents of which are incorporated herein by reference.

### BACKGROUND OF THE INVENTION

1. Field of the Invention

The present invention relates to controls for electronic devices, more specifically to an ergonomic remote control glove for military applications.

2. Brief Description of Related Art

Current electronic devices frequently include button pads or switch pads for controlling them. These button pads and switch pads can be easily lost and are not ergonomic. Soldiers, for instance, frequently use extremely sophisticated electronic devices that require tuning, focusing, adjusting and the like. The button pads and switch pads for these functions may be tethered to the soldier or to the electronic device, but are still easily lost or dropped. The button pad occupies at least one of the user's hands, is cumbersome and time consuming, and is not ergonomic. For example, when the soldier is focusing through the scope of a weapon, in order to modify the electronic device the soldier may have to break the focus and use the button pad.

### SUMMARY OF THE INVENTION

An ergonomic remote control glove is disclosed. According to an aspect of the present subject matter, the ergonomic remote control glove includes at least one motion sensor. Further, the ergonomic remote control glove includes a processor communicatively coupled to the at least one motion sensor. Furthermore, the ergonomic remote control glove includes a communication link to connect to the electronic device. For example, the communication link is communicatively coupled to the processor. In addition, the ergonomic remote control glove includes a power source to power the at least one motion sensor, the processor, and the communication link. Moreover, the ergonomic remote control glove includes a wearable ergonomic glove configured to include the at least one motion sensor, the processor and the communication link.

In operation, the processor is configured to send one or more control signals to the electronic device via the communication link upon detecting finger motions and/or hand gestures of a user by the at least one motion sensor.

According to another aspect of the present subject matter, the ergonomic remote control glove includes the at least one motion sensor and one or more biometric sensors. Further, the ergonomic remote control glove includes the processor communicatively coupled to the at least one motion sensor and the biometric sensors. Furthermore, the ergonomic remote control glove includes the communication link to connect to the electronic device. For example, the communication link is communicatively coupled to the processor. In addition, the ergonomic remote control glove includes the power source to power the at least one motion sensor, the biometric sensors, the processor, and the communication link. Also, the ergonomic remote control glove includes a wearable ergonomic glove configured to include the at least one motion sensor, the biometric sensors, the processor and the communication link.

In operation, the processor is configured to send the one or more control signals to the electronic device via the communication link upon detecting the finger motions and/or hand gestures of the user by the at least one motion sensor. Further, the processor is configured to transmit data about user's life signs and physical condition upon monitoring the user's heart rate, pulse and/or physical conditions by the biometric sensors.

### BRIEF DESCRIPTION OF THE DRAWINGS

The advantages and features of the present disclosure will become better understood with reference to the following detailed description and claims taken in conjunction with the accompanying drawings, wherein like elements are identified with like symbols, and in which:

FIG. 1 illustrates an ergonomic remote control glove for controlling electronic devices, according to an embodiment of the present subject matter;

FIG. 2 is a block diagram of the ergonomic remote control glove, such as the one shown in FIG. 1, providing control inputs to the electronic device via a communication link, according to an embodiment of the present subject matter; and

FIG. 3 illustrates an exemplary computer system suitable for implementing some aspects of the present subject matter.

### DETAILED DESCRIPTION OF THE INVENTION

The exemplary embodiments described herein in detail for illustrative purposes arc subject to many variations in structure and design.

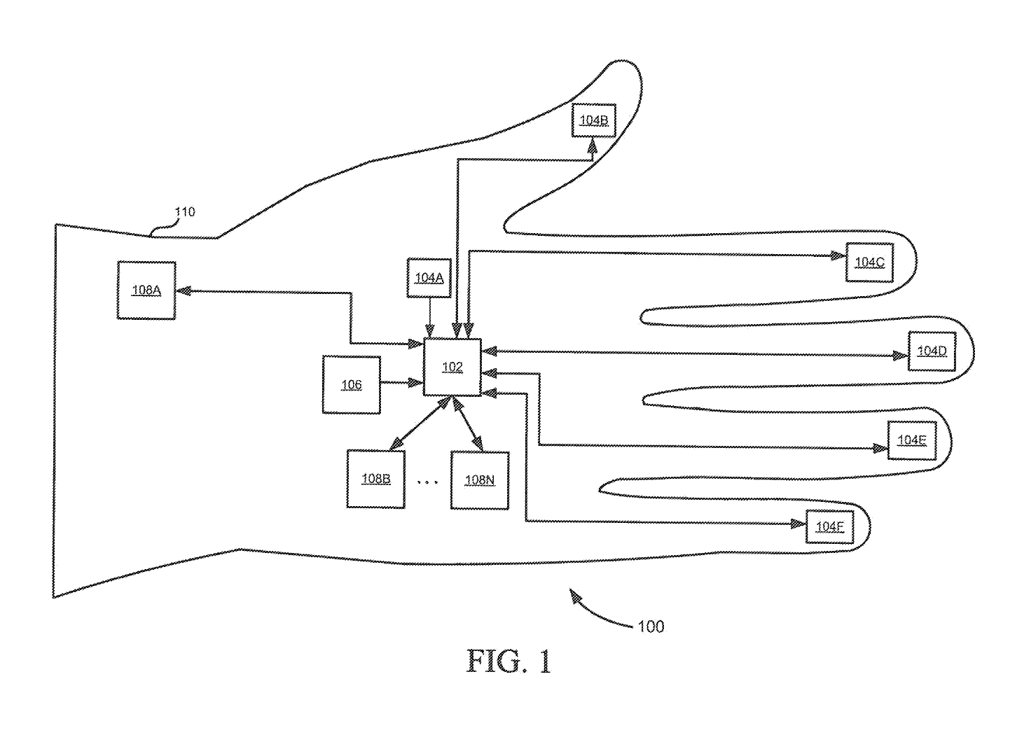

FIG. 1 illustrates an ergonomic remote control glove 100 for controlling electronic devices, according to an embodiment of the present subject matter. For example, the electronic devices include a focusing goggle, a weapon site, a handheld electronic device and the like. As shown in FIG. 1, the ergonomic remote control glove 100 includes a processor 102, a plurality of motion sensors 104A-F, a power source 106, a plurality of biometric sensors 108A-N and a wearable ergonomic glove 110. Exemplary motion sensors 104A-F include an accelerometer, a gyro sensor, a multi-axis motion sensor, and the like. Further, the ergonomic remote control glove 100 includes a communication link to connect to the electronic device. In one embodiment, the communication link is communicatively coupled to the processor 102. For example, the communication link includes a wired and/or wireless communication link. Exemplary wireless communication link includes a WiFi link, a Bluetooth link and the like.

Furthermore, the motion sensors 104A-F and biometric sensors 108A-N are communicatively coupled to the processor 102. In addition, the power source 106 is configured to power the motion sensors 104A-F, biometric sensors 108A-N, the processor 102, and the communication link. For example, the power source 106 includes a battery and the like. Also, the wearable ergonomic glove 110 is configured to include the motion sensors 104A-F, biometric sensors 108A-N, processor 102, power source 106 and communication link.

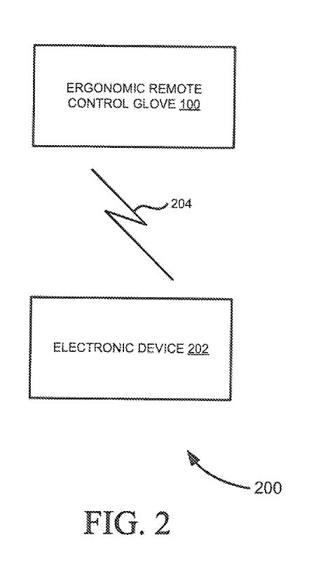

In operation, the processor 102 is configured to send one or more control signals to the electronic device via the communication link upon detecting finger motions, hand gestures and the like of a user by at least one of the motion sensors 104A-F. For example, the control signals are used to control the electronic device. Further, the processor 102 is configured to transmit data about user's life signs and physical condition to the electronic device upon monitoring the user's heart rate, pulse, physical conditions and the like by the biometric sensors 108A-N. This is explained in more detail with reference to FIG. 2.

Referring now to FIG. 2, which is a block diagram 200 that illustrates the ergonomic remote control glove 100, such as the one shown in FIG. 1, providing control inputs to an electronic device 202 via a communication link 204, according to an embodiment of the present subject matter. For example, the ergonomic control glove 100 is worn on a user's hand. In one embodiment, the ergonomic remote control glove 100 detects finger motions and/or hand gestures of a user (e.g., a soldier) and sends one or more control signals to the electronic device 202 via the communication link 204 upon detecting the finger motions and/or hand gestures of the user. For example, the ergonomic remote control glove 100 is programmed to detect the finger motions and/or hand gestures of the user and sends the one or more control signals to the electronic device 202 via the communication link 204 upon detecting the finger motions and/or hand gestures of the user. For example, the ergonomic control glove 100 allows the soldier to focus and target an interactive weapon site without breaking concentration, a line of sight, a weapon position and the like using finger motions and/or had gestures. In another embodiment, the ergonomic remote control glove 100 monitors the user's heart rate, pulse and/or physical conditions and transmits data about user's life signs and physical condition to the electronic device 202 via the communication link 204.

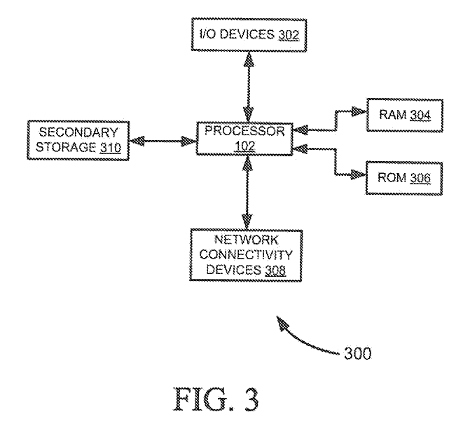

Referring now to FIG. 3, which is an exemplary computer system 300 suitable for implementing some aspects of the present subject matter. As shown in FIG. 3, the computer system 300 includes the processor 102, input/output (I/O) devices 302, a secondary storage 310, a random access memory (RAM) 304, a read only memory (ROM) 306, and network connectivity devices 308. For example, the processor 102 is implemented as one or more central processing unit (CPU) chips.

It is understood that by programming and/or loading executable instructions onto the computer system 300, at least one of the processor 102, the RAM 304, and the ROM 306 are changed, transforming the computer system 300 in part into a particular machine or apparatus having the novel functionality taught by the present disclosure. It is fundamental to the electrical engineering and software engineering arts that functionality that can be implemented by loading executable software into a computer can be converted to a hardware implementation by well known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

For example, the secondary storage 310 includes one or more disk drives or tape drives and is used for nonvolatile storage of data and as an overflow data secondary storage if the RAM 304 is not large enough to hold all working data. Further, the secondary storage 310 is used to store programs which are loaded into the RAM 304 when such programs are selected for execution. Furthermore, the RAM 304 is used to store volatile data and perhaps to store instructions. The ROM 306 is a non-volatile memory de ice which typically has a small memory capacity relative to the larger memory capacity of the secondary storage 310. In addition, the ROM 306 is used to store instructions and perhaps data which are read during program execution. Access to both the ROM 306 and RAM 304 is typically faster than to the secondary storage 310.

For example, the I/O devices 302 include printers, video monitors, liquid crystal displays (LCDs), touch screen displays, keyboards, keypads, switches, dials, mice, track balls, voice recognizers, card readers, paper tape readers, and the like. Further, the network connectivity devices 308 include modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA) and/or global system for mobile communications (GSM) radio transceiver cards, and the like. The network connectivity devices 308 enable the processor 102 to communicate with the Internet or one or more intranets. With such a network connection, it is contemplated that the processor 102 receives information from the network or output information to the network in the course of performing the above-described method steps. Such information, which is often represented as a sequence of instructions to be executed using processor 102, is received from and outputted to the network, for example, in the form of a computer data signal embodied in a carrier wave.

Such information, which includes data or instructions to be executed using the processor 102, for example, is received from and outputted to the network, for example, in the form of a computer data baseband signal or signal embodied in a carrier wave. The baseband signal or signal embodied in the carrier wave generated by the network connectivity devices 308 propagates in or on the surface of electrical conductors, in coaxial cables, in waveguides, in optical media, for example optical fiber, or in the air or free space. The information contained in the baseband signal or signal embedded in the carrier wave may be ordered according to different sequences, as may be desirable for either processing or generating the information or transmitting or receiving the information. The baseband signal or signal embedded in the carrier wave, or other types of signals currently used or hereafter developed, referred to herein as the transmission medium, is generated according to several methods well known to one skilled in the art. The processor 102 executes instructions, codes, computer programs, scripts which it accesses from the hard disk, floppy disk, optical disk, ROM 306, RAM 304, or network connectivity devices 308.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present disclosure.

What is claimed is:

1. An ergonomic remote control glove for controlling an electronic device in military applications, comprising:
at least one motion sensor;
a processor communicatively coupled to the at least one motion sensor;
a communication link to connect to the electronic device, wherein the communication link is communicatively coupled to the processor; and
a wearable ergonomic glove configured to include the at least one motion sensor, the processor and the communication link, wherein the processor is configured to send one or more control signals to the electronic device via the communication link upon detecting finger motions and/or hand gestures by the at least one motion sensor.

2. The ergonomic remote control glove of claim 1, wherein the communication link comprises a wired and/or wireless communication link.

3. The ergonomic remote control glove of claim 2, wherein the wireless communication link comprises a WiFi link and/or a Bluetooth link.

4. The ergonomic remote control glove of claim 1, wherein the electronic device is selected from the group consisting of a focusing goggle, a weapon site, and a handheld electronic device.

5. The ergonomic remote control glove of claim 1, further comprising:
one or more biometric sensors communicatively coupled to the processor, wherein the processor is configured to transmit data about user's life signs and physical condition to the electronic device via the communication link upon monitoring user's heart rate, pulse and/or physical conditions by the one or more biometric sensors.

6. The ergonomic remote control glove of claim 1, wherein the at least one motion sensor is selected from the group consisting of an accelerometer, a gyro sensor, and a multi-axis motion sensor.

7. The ergonomic remote control glove of claim 1, further comprising:
a power source to power the at least one motion sensor, the processor, and the communication link.

8. The ergonomic remote control glove of claim 7, wherein the power source is a battery.

9. An ergonomic remote control glove for controlling an electronic device in military applications, comprising:
at least one motion sensor;
one or more biometric sensors;
a processor communicatively coupled to the at least one notion sensor and the one or more biometric sensors;
a communication link to connect to the electronic device, wherein the communication link is communicatively coupled to the processor; and
a wearable ergonomic glove configured to include the at least one motion sensor, the processor, the one or more biometric sensors and the communication link, wherein the processor is configured to send one or more control signals to the electronic device via the communication link upon detecting finger motions and/or hand gestures by the at least one motion sensor and wherein the processor is configured to transmit data about user's life signs and physical condition to the electronic device via the communication link upon monitoring user's heart rate, pulse and/or physical conditions by the one or more biometric sensors.

10. The ergonomic remote control glove of claim 9, further comprising:
a power source to power the at least one motion sensor, the one or more biometric sensors, the processor, and the communication link.
